(19) United States
(12) Patent Application Publication
(10) Pub. No.: US 2009/0110192 A1
(43) Pub. Date: Apr. 30, 2009

(54) SYSTEMS AND METHODS FOR ENCRYPTING PATIENT DATA

(75) Inventors: Mark A. Elrod, Cary, IL (US); Sophia S. Siraki, Crystal Lake, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/928,261

(22) Filed: Oct. 30, 2007

(51) Int. Cl. H04L 9/28

(52) U.S. Cl. 380/44

(57) ABSTRACT

Certain embodiments of the present invention provide a method for protecting electronic patient data in a healthcare environment. The method includes selecting the patient data to be protected, selecting a biometric identifier from a patient, generating an encryption key based on the biometric identifier, and encrypting the patient data. The method may also include authenticating the encrypted patient data. The biometric identifier may be a DNA sequence. The method may also include applying a hash function to the DNA sequences to obtain a hash value. The encryption key may be based at least in part on the hash value.

### BACKGROUND OF THE INVENTION

The present invention generally relates to protecting and authenticating patient data. More specifically, the present invention relates to systems and methods for encrypting patient data using an encryption key based at least in part on a unique patient identifier, such as a biometric identifier (e.g., DNA).

Healthcare environments, such as hospitals or clinics, include storage systems, such as picture archiving and communication systems (PACS), library information systems (LIS), and electronic medical records (EMR). Information stored may include patient data in the form of medical histories, imaging data, test results, diagnosis information, management information, and/or scheduling information, for example. Data about each patient is collected by a variety of computer systems and may be entered by a variety of medical personnel. For example, medical personnel may enter new patient data, such as history, diagnostic, or treatment information, into an EMR during an ongoing medical procedure.

A variety of distractions in a clinical environment may frequently interrupt medical personnel or interfere with their job performance. Data entry is complicated in a typical healthcare facility and may be prone to error. Associating patient data with the wrong patient may result in inefficient workflow and service to clients, which may impact a patient's health and safety or result in liability for a healthcare facility. Insuring that correct patient data is associated with the correct patient is obviously critical for patient safety.

Likewise, unidentified patients who are unconscious or unable to communicate sometimes receive medical treatment. Such patients may have received prior treatment and any previously collected patient data may be useful to inform subsequent treatment decisions. For example, when healthcare personnel are making a diagnosis for a patient, they often need to find relevant historical information for the patient to better understand the patient's clinical history. However, in the case of an unidentified, non-communicative patient, healthcare personnel would not be able to find archived patient data without some way to identify the patient.

In a clinical setting, especially in a clinical research setting, great care is taken to maintain patient privacy. For example, the name of a patient is often removed from patient data in the interest of patient privacy. Often only a medical record number or a study identification number is used to identify a patient. However, these identifiers are prone to error because they are not inherently associated with the patient.

Biometric identifiers are inherent physical characteristics useful for identifying individuals. Biometric identifiers include, for example, fingerprints, retinal scans, facial patterns, hand measurements, and DNA sequences. For example, the uniqueness of a patient's DNA sequence makes the DNA sequence a good candidate to identify patients. Moreover, a patient's DNA sequence may be a useful authentication tool because the DNA sequence is inherently associated with the patient.

U.S. Pat. No. 7,107,246 mentions, by way of example, user identification data as including biometric identifiers, such as fingerprints and DNA sequences. U.S. Pat. No. 7,103,772 refers to delivering network security solutions using biometric identifiers to verify user authorization. U.S. Pat. No. 7,082,213 refers to a method for identity verification employing biometric technology. U.S. Pat. No. 7,157,228 discusses methods for correlating the results of genetic testing with a unique marker that unambiguously identifies an organism. U.S. Pat. No. 5,680,460 refers to generating a key under the control of a biometric, such as a fingerprint.

However, existing systems and methods for protection and authentication of patient data do not utilize biometric identifiers as a tool to encrypt patient data. Consequently, existing systems and methods for protection and authentication of patient data often rely on random patient identifiers that are prone to error, endangering the health and safety of the patient.

Therefore, a need exists for systems and methods for encrypting patient data using an encryption key based at least in part on a unique patient identifier, such as a biometric identifier (e.g., DNA).

### BRIEF SUMMARY OF THE INVENTION

Certain embodiments of the present invention provide a method for protecting electronic patient data in a healthcare environment. The method includes selecting a biometric identifier from a patient and generating an encryption key based at least in part on the biometric identifier. The method may also include selecting the patient data to be protected and encrypting the patient data. The method may also include authentication of the encrypted patient data. The method may also include storing, retrieving, and decrypting the encrypted data. The biometric identifier may be a DNA sequence. The method may also include applying a hash function to the DNA sequence to obtain a hash value. The encryption key may be based at least in part on the hash value.

Certain embodiments of the present invention provide a system for encrypting patient data. The system includes a key-generating component adapted to generate an encryption key based a biometric identifier. The system may also include an encryption component adapted to encrypt the patient data using the generated encryption key and a storage component adapted to store the encrypted patient data. The system may also include a decryption component adapted to decrypt the encrypted data.

Certain embodiments of the present invention provide a method for generating an encryption key. The method includes selecting a biometric identifier and generating an encryption key that is based at least in part on the biometric identifier. The method may also include selecting a patient DNA sequence, applying a hash function to the DNA sequence to obtain a hash value, and generating an encryption key based at least in part on the hash value. The method may employ DNA sequences that uniquely identify an individual patient.

Certain embodiments of the present invention provide a computer-readable storage medium. The computer-readable storage medium includes a set of instructions for execution on a computer. The set of instructions includes a biometric identifier selection routine adapted to select a biometric identifier and a key routine adapted to generate an encryption key based at least in part on the biometric identifier. The set of instructions may also include an encryption routine adapted to encrypting patient data using the encryption key. The biometric identifier may be a DNA sequence.

Certain embodiments of the present invention provide authentication of patient data. Identification errors associated with mishandling, mislabeling and switching of patient data may be corrected or prevented by generating an encryption key based at least in part on the patient's DNA sequence(s) or genetic fingerprint. In this way, an unambiguous link between the patient data and the patient's identity is established. The genetic fingerprint may serve to track and to confirm the identity of the patient data, thereby authenticating the patient data.

### BRIEF DESCRIPTION OF SEVERAL VIEWS OF THE DRAWINGS

FIG. 1 illustrates an exemplary method for protecting and authenticating patient data according to an embodiment of the present invention.

FIG. 2 illustrates a method for encryption of patient data according to an embodiment of the present invention.

FIG. 3 illustrates a method for decryption of patient data according to an embodiment of the present invention.

FIG. 4 depicts an exemplary method for generating an encryption/decryption key according to an embodiment of the present invention.

FIG. 5 illustrates a system for encryption of patient data according to an embodiment of the present invention.

FIG. 6 illustrates a system for decryption of patient data according to an embodiment of the present invention.

FIG. 7 illustrates an exemplary system for encryption/decryption according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE DRAWINGS

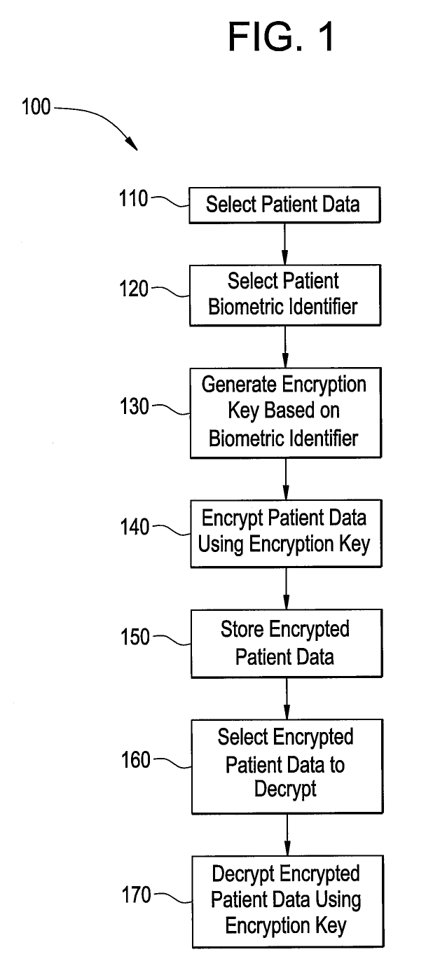

FIG. 1 illustrates a data protection and authentication method 100 according to an embodiment of the present invention. The data protection and authentication method 100 includes the following steps, which are described below in more detail. At step 110, patient data is selected. At step 120, a biometric identifier from that patient is selected. At step 130, an encryption key is generated. At step 140, the selected patient data is encrypted using the encryption key. At step 150, the encrypted patient data is stored. At step 160, encrypted patient data is selected for retrieval and decryption. At step 170, selected encrypted patient data is decrypted using the encryption key.

At step 110, patient data is selected for encryption. The selected patient data may be archived data. For example, the patient data may include previously entered or recorded laboratory test results. Alternatively, the selected data may be data that is being acquired in real-time. For example, an electrocardiogram may be produced in real-time and concurrently selected for encryption. The selected patient data may have been entered or recorded either manually or automatically. Selected patient data may include patient medical histories, imaging data, test results, diagnosis information, management information, and/or scheduling information, for example.

At step 120, a patient biometric identifier is selected. A biometric identifier may include any of those known in the art such as retinal scan, iris recognition, facial recognition and the like.

A patient DNA sequence may also be used as a biometric identifier. The patient DNA sequence may include the patient's entire DNA sequence or, alternatively, only portions of the patient's entire DNA sequence. In certain embodiments of the present invention, the identified DNA sequence provides unambiguous molecular identification of the individual patient. For example, analysis of polymorphisms in a number of repeated sequence elements within certain loci may provide unambiguous molecular identification of individuals. As another example, analysis of single nucleotide polymorphisms (SNP) within short tandem repeats (STR) may provide unambiguous molecular identification of individuals. A DNA sequence used in accordance with the present invention for patient identification may be located in coding or non-coding regions of the genome. Additionally, a DNA sequence used in accordance with the present invention may consist of non-genomic DNA. For example, mitochondrial DNA may be used.

A biometric identifier may be stored in a database for retrieval or acquired contemporaneously with selection. For example, a biometric identifier may be selected upon acquisition. Alternatively, an archived biometric identifier may be selected. For example, a biometric template representing a live fingerprint scan from a fingerprint sensor may be obtained and stored at some earlier date and only later selected at step 120.

At step 130, an encryption key is generated. The encryption key is based, in part, on the selected patient biometric identifier. For example, in the case of a DNA sequence, a hash function may be applied to the DNA sequence to obtain a hash value. The encryption key may then be generated based at least in part on the hash value. As another example, an encryption key may be generated from a fingerprint pattern as described in U.S. Pat. No. 5,680,460.

Additionally, the encryption key may be based at least in part on a private password to protect against unauthorized access. The private portion of the encryption key would provide additional security for the patient data. The private portion of the encryption key may be automatically generated. The biometric identifier and the private password may be combined into for a single encryption key.

At step 140, the selected patient data is encrypted using the encryption key. The encryption may occur by any recognized encryption method. For example, block ciphers such as Triple DES or Advanced Encryption Standard (AES), or stream ciphers, such as RC4 or MUGI, may be used to encrypt patient data. As another example, RSA encryption may be used to encrypt patient data.

At step 150, the encrypted patient data may be stored in any commonly available storage systems, such as a medical information system, for example.

At step 160, encrypted patient data may be selected for retrieval and decryption. Healthcare practitioners may desire to access patient data at various points in a healthcare workflow. For example, during a follow-up examination, medical personnel may access patient data, such as previous test results, that are stored in a medical information system.

At step 170, selected encrypted patient data is decrypted using the encryption key. Encrypted patient data can only be decrypted by using the appropriate encryption key. For example, encrypted data may be decrypted only by using an encryption key that is based on the patient's own biometric identifier. Basing at least a part of the encryption key on a patient's own biometric identifier serves to authenticate the archival patient data.

One or more of the steps 110-170 of the method 100 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

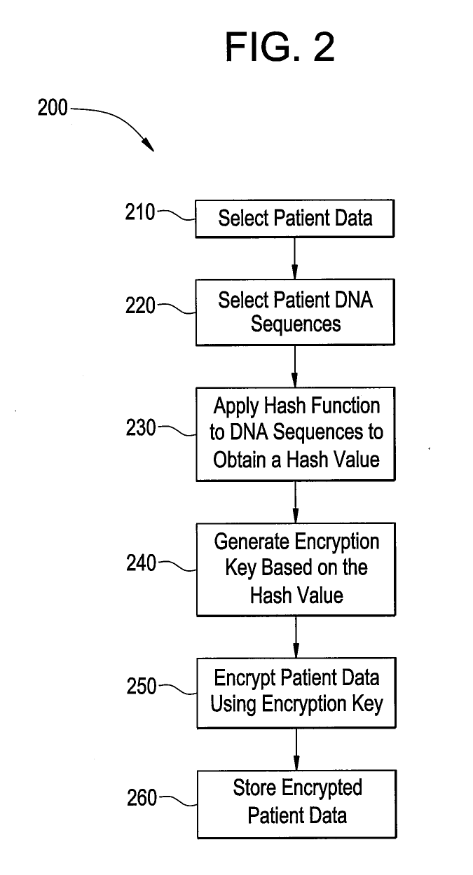

FIG. 2 illustrates an encryption method 200 according to an embodiment of the present invention. The encryption method 200 includes the following steps, which are described below in more detail. At step 210, patient data is selected. At step 220, patient DNA sequences are selected. At step 230, a hash function is applied to the identified DNA sequences. At step 240, an encryption key is generated. At step 250, patient data is encrypted using the encryption key. At step 260, encrypted patient data is stored.

At step 210, patient data is selected for encryption. Selected patient data may include patient medical histories, imaging data, test results, diagnosis information, management information, and/or scheduling information, for example. The selected patient data may be archived data. For example, the patient data may include previously entered or recorded laboratory test results. Alternatively, the selected data may be data that is being acquired in real-time. For example, an electrocardiogram may be produced in real-time and concurrently selected for encryption. The selected patient data may have been entered or recorded automatically. For example, a monitor device may read blood pressure from a patient and send that data to a computer.

At step 220, patient DNA sequences are selected. Patient DNA sequences may be stored in a database for retrieval or acquired contemporaneously with selection. For example, genomic DNA may be extracted from a patient, sequenced using routine extraction and sequencing methods, and selected according to step 210. Alternatively, an archived DNA sequences may be selected. Once a DNA sequence has been obtained, the information may be stored and selected according to step 210 at some later date.

At step 230, a hash function is applied to the patient DNA sequences to obtain a hash value. Any widely used cryptographic hash function such as MD5, SHA-1, SHA-224, SHA-256, SHA-384, SHA-512, RIPEMD-128, or RIPEMD-60 may be employed in step 220. For example, standard MD5 128 bit hashing function may be applied to contents of file that contains a DNA sequence. The 128 bit hash result may be stored in a separate file for quick access.

At step 240, an encryption key is generated based on the hash value. The encryption key may be based at least in part on a DNA sequence provided by the patient. For example, an encryption key may be generated based at least in part on the hash value obtained in step 230. An archived hash value may be used. For example, software running on a computer may read an archived 128 bit hash value of patient DNA sequence from a file. An encryption key may then be generated using the archived 128 bit hash value of patient DNA sequence.

Additionally, the encryption key may be based at least in part on a private password to protect against unauthorized access. The private portion of the encryption key would provide additional security for the selected patient data. The private portion of encryption key may be automatically generated. For example, the hash value obtained in step 230 and the private password may be combined into for a single encryption key.

At step 250, selected patient data is encrypted using the encryption key. The encryption may occur by any recognized encryption method. For example, block ciphers such as Triple DES or Advanced Encryption Standard (AES), or stream ciphers, such as RC4 or MUGI, may be used to encrypt patient data. As another example, R§A encryption may be used to encrypt patient data.

At step 260, encrypted patient data is stored. Encrypted patient data may be stored on any computer-readable storage and retrieval device that is accessible over an intranet or over the Internet. An encrypted data file may be saved for the patient in any commonly available storage device. For example, encrypted patient data may be stored in a medical information system or an electronic medical record.

### EXAMPLE 1

### Encryption of Patient Data

As an example, patient data may be encrypted as follows:

A monitor device reads blood pressure from a patient and sends the data to a computer.

The software running on the computer reads 128 bit hash value of patient DNA sequence from a file.

The software then reads the private password used to encrypt data from a file.

The 128 bit hash value and the private password are combined to form a single key for encryption.

The single encryption key is used to encrypt the blood pressure data of the patient along with a check sum value to insure data integrity.

The encrypted data file is saved for the patient.

One or more of the steps 210-260 of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

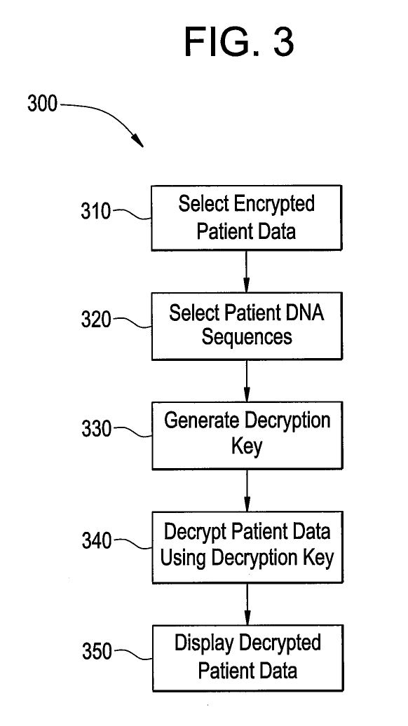

FIG. 3 illustrates a decryption method 300 according to an embodiment of the present invention. The decryption method 300 includes the following steps, which are described below in more detail. At step 310, encrypted patient data is selected. At step 320, patient DNA sequences are selected. At step 330, a decryption key is generated. At step 340, patient data is decrypted using the encryption key. At step 350, decrypted patient data is displayed.

At step 310, encrypted patient data is selected for decryption. Encrypted patient data may include patient medical histories, imaging data, test results, diagnosis information, management information, and/or scheduling information, for example. Healthcare practitioners may desire to access encrypted patient data at various points in a healthcare workflow. For example, during a follow-up examination, medical personnel may wish to access encrypted patient data, such as previous test results, that are stored in a medical information system. A user may select an encrypted patient file with software, for example.

At step 320, patient DNA sequences are selected. Patient DNA sequences may be stored in a database for retrieval. An archived DNA sequence may be selected. Alternatively, DNA may be extracted from a patient and sequenced using routine sequencing methods.

At step 330, a decryption key is generated. The decryption key may be based at least in part on a DNA sequence provided by the patient. For example, the decryption key may be based at least in part on a hash value obtained by applying a hash function to a DNA sequence. An archived hash value obtained may be used. For example, software running on a computer may read an archived 128 bit hash value of patient DNA sequence from a file. A decryption key may then be generated using the archived 128 bit hash value of patient DNA sequence.

Additionally, the decryption key may be based at least in part on a private password to protect against unauthorized access. For example, a hash value obtained by applying a hash function to a DNA sequence and a private password may be combined into for a single decryption key. The private portion of the decryption key would provide additional security for the encrypted patient data. The private portion of decryption key may be automatically generated.

At step 340, selected patient data is decrypted using the decryption key. Encrypted patient data may be decrypted only by using a decryption key that is based on the patient's own DNA sequence.

At step 350, decrypted patient data is displayed. Decrypted patient data may be displayed on an output device such as a computer monitor, for example. Decrypted patient data may be displayed on any device capable of presenting or displaying decrypted patient data to a user. Therefore, decrypted patient data may also be displayed on an output device embodied in a wireless output device, for example.

### EXAMPLE 2

### Decryption of Patient Data

As an example, the encrypted blood pressure data described in Example 1 may be decrypted as follows:

A user selects the encrypted patient file with software.

The software opens the patient file and reads the encrypted data.

The software reads 128 bit hash value of patient DNA sequence from a file.

The software reads the private password used to encrypt data from a file.

The 128 bit hash value and the private password are combined to for a single key for encryption.

The single encryption key is used to decrypt the blood pressure data of the patient along with a check sum value.

The check sum of the data is verified

The patient data is displayed for the user.

One or more of the steps 310-350 of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

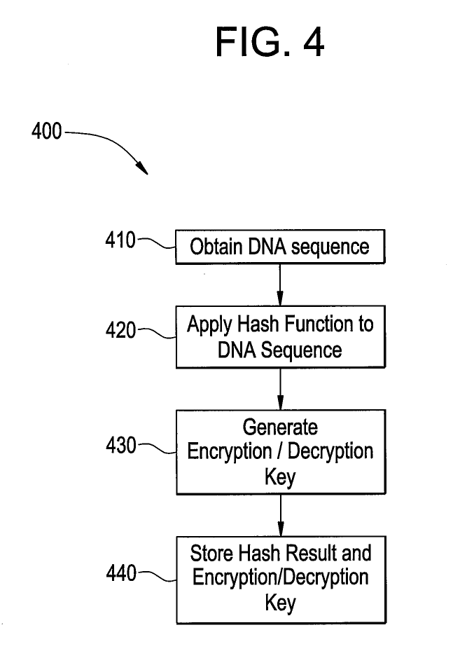

FIG. 4 illustrates an exemplary encryption/decryption key generating method 400 according to an embodiment of the present invention. The key generating method 400 is adapted to generating an encryption/decryption key and includes the following steps, which are described in more detail below. At step 410, a DNA sequence is obtained. At step 420, a hash function is applied to the DNA sequence. At step 430, the hash result is stored.

At step 410, a DNA sequence is obtained. The DNA sequence may be obtained from a file, for example. Alternatively, a DNA sequence may be obtained by extracting DNA from a patient and sequencing the DNA using routine sequencing methods,

At step 420, a hash function is applied to the DNA sequence to obtain a hash result or a hash value. Any widely used cryptographic hash function such as MD5, SHA-1, SHA-224, SHA-256, SHA-384, SHA-512, RIPEMD-128, or RIPEMD-60 may be employed in step 420. For example, standard MD5 128 bit hashing function may be applied to contents of file that contains a DNA sequence.

At step 430, an encryption/decryption key based at least in part on the hash value is generated.

At step 440, the hash result and the encryption/decryption key may be stored. For example, the hash result may be stored in any commonly available storage system, such as a medical information system or an electronic medical record. For example, the 128 bit hash result may be stored in a separate file for quick access.

### EXAMPLE 3

### Generation of an Encryption Key by Creating 128 Bit Hash Value of Patient DNA Sequence

As an example, an encryption key may be generated as follows:

The DNA sequence is obtained from a file.

Standard MD5 128 bit hashing function is applied to contents of file.

The 128 bit hash result is stored in a separate file for quick access.

One or more of the steps 410-440 of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

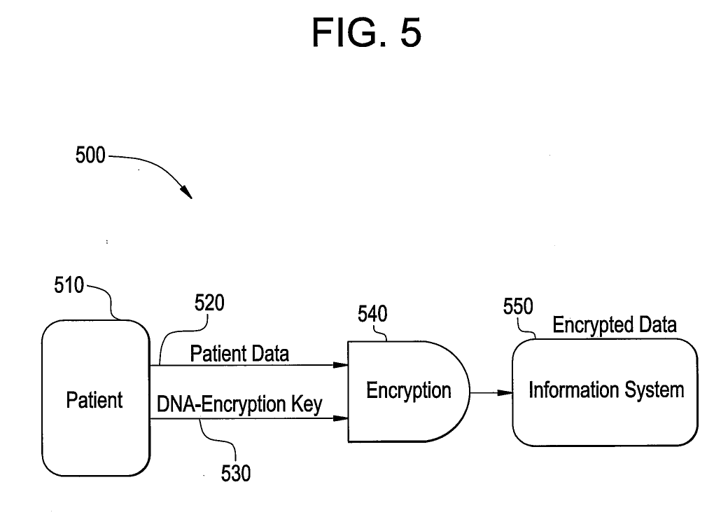

FIG. 5 illustrates an exemplary encryption system 500 according to an embodiment of the present invention. The encryption system 500 includes a patient 510, patient data 520, an encryption key 530, an encryption component 540, and an information system 550.

Patient data 520 may be obtained from patient 510. Patient data 520 may consist of archived medical information or contemporaneously acquired medical information. For example, patient data 520 may include previously entered or recorded laboratory test results. Alternatively, patient data 520 may include an electrocardiogram produced in real-time. Patient data 520 may include patient medical histories, imaging data, test results, diagnosis information, management information, and/or scheduling information, for example.

Encryption key 530 may be based at least in part on a DNA sequence provided by patient 410. For example, a hash function may be applied to the DNA sequence to obtain a hash value. Any widely used cryptographic hash function may be employed. For example, MD5, SHA-1, SHA-224, SHA-256, SHA-384, SHA-512, RIPEMD-128, or RIPEMD-60 hash functions may be used. Encryption key 530 may then be generated based at least in part on the hash value.

Additionally, encryption key 530 may be based at least in part on a private password to protect against unauthorized access. The private portion of encryption key 530 would provide additional security for patient data 520. The private portion of encryption key 530 may be automatically generated. For example, the hash value based at least in part on the DNA sequence extracted from patient 510 and the private password may be combined into for a single encryption key 530.

Encryption component 540 may be adapted to encrypt patient data 520 using encryption key 530. Encryption component 540 may use any recognized encryption method. For example, block ciphers such as Triple DES or Advanced Encryption Standard (AES), or stream ciphers, such as RC4 or MUGI, may be used to encrypt patient data 520. As another example, RSA encryption may be used to encrypt patient data.

Information system 550 may be adapted to store encrypted patient data. Information system 550 may include any commonly available storage system, such as a medical information system or an electronic medical record.

As discussed above, the components, elements, and/or functionality of the system 500 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

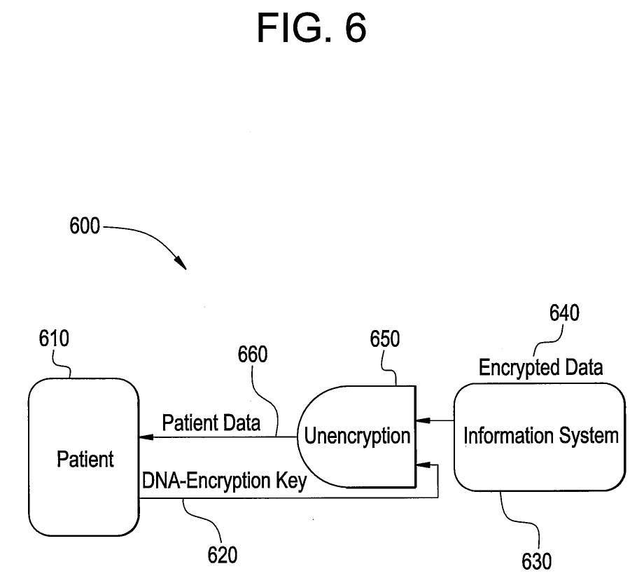

FIG. 6 illustrates an exemplary decryption system 600 according to an embodiment of the present invention. The decryption system 600 includes a patient 610, an encryption key 620, an information system 630, encrypted data 640, a decryption component 650, and unencrypted patient data 660.

DNA sequences may be obtained from patient 610. Patient DNA sequences may be archived and subsequently obtained from a database. For example, software may read an archived 128 bit hash value of patient DNA sequence from a file. Alternatively, DNA may be extracted from patient 610 and sequenced using routine sequencing methods.

Encryption key 620 may be based at least in part on a DNA sequence extracted from patient 610. For example, a hash function may be applied to the DNA sequence to obtain a hash value. Any widely used cryptographic hash function may be employed. For example, MD5, SHA-1, SHA-224, SHA-256, SHA-384, SHA-512, RIPEMD-128, or RIPEMD-60 hash functions may be used. Encryption key 620 may be based at least in part on the hash value obtained by applying a hash function to a DNA sequence.

Information system 630 may contain stored data, including encrypted data 640. Healthcare practitioners may desire to access encrypted data 640 at various points in a healthcare workflow. For example, during a follow-up examination, medical personnel may wish to access encrypted data 640, such as previous test results, that are stored in information system 630. Information system 630 may include any commonly available storage system, such as a medical information system or an electronic medical record.

Decryption component 650 may be adapted to decrypt encrypted data 640 using the encryption key 630. Thus, decryption component 650 may provide unencrypted patient data 660. Decryption component 650 can only decrypt encrypted data 640 by using encryption key 630. For example, encrypted data 640 may be decrypted only by using encryption key 630 that is based on the patient's own DNA sequence.

As discussed above, the components, elements, and/or functionality of the system 600 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

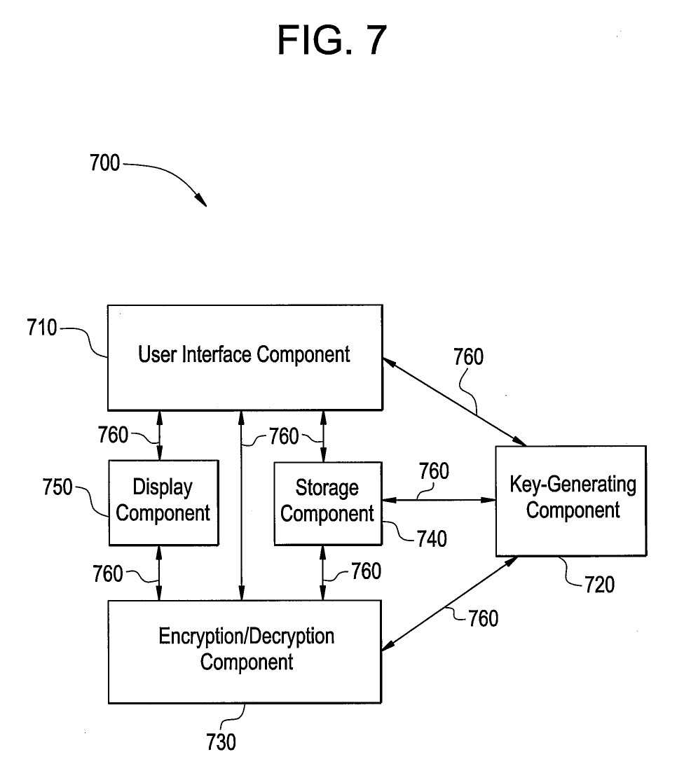

FIG. 7 illustrates an exemplary DNA-based encryption/decryption system 700 according to an embodiment of the present invention. The encryption/decryption system 700 includes a user interface component 710, a key-generating component 720, an encryption/decryption component 730, a storage component 740, a display component 750, and communication components 760.

User interface component 710 is adapted to input and access patient data and DNA sequences. User interface component 710 may include an input device such as a keyboard, mouse, stylus, or microphone. For example, a user may input patient data using a keyboard. Data input may also occur automatically and contemporaneously to data collection. For example, a monitor device may read blood pressure from a patient and send the data directly to a computer. As another example, a user may select an archived patient file using a keyboard or mouse.

Key-generating component 720 is adapted to generate an encryption/decryption key based on a DNA sequence. For example, software may read an archived 128 bit hash value of patient DNA sequence from a file. The software may also read a private password used to encrypt data from a file. Key-generating component 720 may combine the 128 bit hash value and the private password to form a single key for encryption/decryption.

Encryption/decryption component 730 is adapted to encrypt/decrypt patient data using the encryption/decryption key generated by key-generating component 720. For example, the single encryption/decryption key generated by key-generating component 720 may be used to encrypt the blood pressure data of the patient. As another example, encryption/decryption component 730 may provide unencrypted patient data. Encryption/decryption component 730 can only decrypt encrypted data by using the encryption/decryption key generated by key-generating component 720. For example, encrypted patient data may be decrypted only by using an encryption/decryption key that is based at least in part on the patient's own DNA sequence.

Storage component 740 may contain archived data, including encrypted data. Healthcare practitioners may desire to access encrypted data at various points in a healthcare workflow. For example, during a follow-up examination, medical personnel may wish to access encrypted data, such as previous test results, that are stored in storage component 740. Storage component 740 may also contain archived DNA sequences. For example, a DNA sequence stored in storage component 740 may be retrieved and used to generate an encryption/decryption key by key-generating component 720. Storage component 740 may include any commonly available machine-readable media, such as RAM, ROM, PROM, EPROM, EEPROM, Flash, CD-ROM or other optical disk storage, magnetic disk storage or other magnetic storage devices, or any other medium which can be used to carry or store desired information in the form of machine-executable instructions or data structures and which can be accessed by a general purpose or special purpose computer or other machine with a processor.

Display component 750 is adapted to display decrypted patient data. Display component 750 may be a computer monitor, for example. Display component 750 includes any device capable of presenting or displaying decrypted patient data to a user. Therefore, display component 750 may also be embodied in a wireless output device, for example.

Communication components 760 are adapted to communicate between various components of system 700. Communication between various components may occur over hardwired, wireless, or a combination of hardwired or wireless connections.

As discussed above, the components, elements, and/or functionality of the system 700 may be implemented alone or in combination in various forms in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

The terms “encryption” and “decryption” are used extensively throughout this application to refer to two separate processes. However, it is recognized that encryption and decryption are polar opposites and, therefore, the terms “encryption” and “decryption” have been used interchangeably throughout. For example, a key may be used to encrypt patient data. In that context, the key may be called an “encryption key”. That same key also may be used to decrypt encrypted patient data, and, in that context, be referred to as a “decryption key”.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any image sharing system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for protecting electronic patient data in a healthcare environment, said method including:
selecting one or more biometric identifiers from a patient; and
generating an encryption key, wherein said encryption key is based at least in part on said one or more biometric identifiers.

2. The method of claim 1 further including selecting said electronic patient data to be protected.

3. The method of claim 1 further including encrypting said patient data using said encryption key.

4. The method of claim 3 further including storing said encrypted patient data.

5. The method of claim 4 further including selecting said encrypted patient data for retrieval.

6. The method of claim 5 further including decrypting said encrypted patient data using said encryption key.

7. The method of claim 6 wherein said method also authenticates said encrypted patient data.

8. The method of claim 1 wherein said biometric identifier includes one or more DNA sequences.

9. The method of claim 8 wherein a hash function is applied to said one or more DNA sequences to obtain a hash value.

10. The method of claim 9 wherein said encryption key is based at least in part on said hash value.

11. The method of claim 8 wherein said one or more DNA sequences are identified automatically.

12. The method of claim 8 wherein identification of said one or more DNA sequences includes extracting genomic DNA from said patient and sequencing said genomic DNA.

13. The method of claim 1 wherein said encryption key is based at least in part on a private password

14. A system for encrypting patient data, said system including:
a key-generating component adapted to generate an encryption key based on one or more biometric identifiers.

15. The system of claim 14 further including an encryption component adapted to encrypt said patient data using said encryption key.

16. The system of claim 15 further including a storage component adapted to store said encrypted patient data.

17. The system of claim 15 further including a decryption component adapted to decrypt said encrypted patient data using said encryption key.

18. The system of claim 14 wherein said one or more biometric identifiers include a DNA sequence.

19. A computer-readable storage medium including a set of instructions for a computer, said set of instructions including:
a biometric identifier selection routine adapted to select one or more biometric identifiers from a patient; and
a key routine adapted to generating an encryption key wherein said encryption key is based at least in part on said one or more biometric identifiers.

20. The computer-readable storage medium of claim 19 wherein said biometric identifier includes one or more DNA sequences.
